(19) United States
(12) Patent Application Publication
(10) Pub. No.: US 2018/0254439 A1
(43) Pub. Date: Sep. 6, 2018

(54) A LITHIUM-ION BUTTON CELL

(71) Applicant: VARTA Microbattery GmbH, Ellwangen Jagst (DE)

(72) Inventors: Claus-Christian Fischer, Ellwangen (DE); Winfried Gaugler, Ellwangen (DE); Goran Kilibarda, Schwäbisch Gmünd (DE); Bernd Kreidler, Ellwangen (DE); Hanna Siwek, Ellwangen (DE)

(21) Appl. No.: 15/765,345

(22) PCT Filed: Sep. 2, 2016
(86) PCT No.: PCT/EP2016/070773

§ 371 Date: Apr. 2, 2018

(30) Foreign Application Priority Data
Oct. 2, 2015 (EP) 15188137.2

(51) Int. Cl. H01M 2/02; H01M 10/0525; H01M 10/058; H01M 10/04; H01M 2/08; H01M 4/13; H01M 4/66; H01M 4/80

(52) U.S. Cl. CPC H01M 2/0222; H01M 10/0525; H01M 10/058; H01M 10/0427; H01M 2/0285; H01M 2/026; H01M 2004/028; H01M 4/13; H01M 4/662; H01M 4/80; H01M 4/806; H01M 4/808; H01M 2/08

(57) ABSTRACT

A button cell on a lithium-ion basis includes a housing sealed in a fluid-tight fashion and composed of a positively-poled metallic housing half and a negatively-poled metallic housing half, which halves are separated from one another by an electrically-insulating seal. A positive electrode and a negative electrode are arranged inside the housing. The positive electrode is in electrical contact with the positively-poled housing half, and the negative electrode is in electrical contact with the negatively-poled housing half. An ion-conductive separator is arranged between the electrodes. The positive electrode includes a metallic current collector. A porous three-dimensional structure whose pores are filled with a suitable electrochemically-active material serves as such a current collector. During the manufacturing of the button cell, the structure is connected to the positively-poled housing half by welding.

### TECHNICAL FIELD

This disclosure relates to a button cell on a lithium-ion basis.

### BACKGROUND

During the discharging of an electrochemical cell, an energy-producing chemical reaction occurs, which is comprised of two mutually electrically-coupled but spatially-separated sub-reactions. One sub-reaction, with a comparatively low redox potential, proceeds at the negative electrode, and another with a comparatively high redox potential proceeds at the positive electrode. During discharging, electrons are released from the negative electrode by an oxidation process, resulting in an electron stream via an external load to the positive electrode, which receives a corresponding quantity of electrons. A reduction process thus occurs on the positive electrode. At the same time, an ion stream corresponding to the electrode reaction is present within the cell. This ion stream is supported by an ionically-conducting electrolyte. In secondary cells, this discharging reaction is reversible, and it is therefore possible for the conversion of chemical energy into electrical energy associated with discharging to be reversed. When the terms “anode” and “cathode” are employed in this context, the electrodes are generally named according to their discharging function. The negative electrode in such cells is thus the anode, and the positive electrode is the cathode.

A specifically known form of an electrochemical cell is the button cell. A button cell customarily comprises a cylindrical housing formed of positively-poled and negatively-poled metallic housing halves, the height of which is smaller than its diameter. Different electrochemical systems can be accommodated in the housing. Button cells based on a nickel-metal hydride system and on lithium-ions are very widespread. In general, these cells are rechargeable.

In particular, button cells based on lithium-ions have very high energy densities. In such cells, in the context of the above-mentioned charging and discharging processes, lithium ions are taken up or released from electrodes. Very high current-carrying capacities are achieved by button cells with a lithium-ion basis which, in place of conventional solid electrodes, comprise a composite body in the form of a stack of a plurality of flat cells or, alternatively, a cell in wound form. However, forming stacks from a plurality of flat cells is complex, as it is necessary for the cells to be interconnected in a cross-layer arrangement. Corresponding electrical contact arrangements also occupy room, and create a dead space that reduces the energy density of corresponding cells.

Examples of button cells with cells in wound form are disclosed e.g. in DE 10 2009 060 800 A1. In that application, cells in the form of cylindrical windings are described. Conductor strips project from the end faces of the windings, which are electrically connected to a metal housing. However, windings of this type can only be produced in a problem-free manner with effect from a specific minimum thickness. Producing windings with a height of less than 5 mm is difficult. Moreover, thin windings of this type can only be incorporated in customary cell housings with difficulty.

Consequently, the availability of high-performance button cells with a low structural height of ≤5 mm is severely restricted.

It could therefore be helpful to provide button cells with a structural height of ≤5 mm, having a high energy density and capable of delivering high currents.

### SUMMARY

We provide a lithium-ion button cell, including a housing sealed in a fluid-tight fashion, including a positively-poled metallic housing half and a negatively-poled metallic housing half, which halves are separated from one another by an electrically-insulating seal, a positive electrode arranged within the housing and in electrical contact with the positively-poled housing half, a negative electrode arranged within the housing and in electrical contact with the negatively-poled housing half, and an ion-conductive separator arranged in the housing between the positive electrode and the negative electrode, wherein the positive electrode includes a metallic current collector, the metallic current collector is a porous three-dimensional structure, pores of the porous structure are filled with an electrochemically-active material of the positive electrode, and the porous structure is bonded to the positively-poled housing half by welding.

We also provide a method of manufacturing the button cell including providing a positive electrode in a positively-poled housing half, providing a negative electrode in a negatively-poled housing half, providing an electrically-insulating seal, providing an ion-conductive separator, and combining the electrodes, seal and separator in the button cell to be manufactured, wherein the positive electrode, by a metallic current collector in the form of a porous, three-dimensional structure, is bonded to the positively-poled housing half, and the current collector is bonded to the positively-poled housing half by welding.

### BRIEF DESCRIPTION OF THE DRAWINGS

FIG. 1 represents a preferred method of providing a positively-poled housing half 101, with a positive electrode 102 contained therein (a schematic representation, with all components represented in cross section).

FIG. 2 schematically shows an example of one of our button cells produced by the method shown in FIG. 1.

### DETAILED DESCRIPTION

Our button cells are lithium-ion based button cells. This means that they comprise electrodes in which, during charging and discharging processes, lithium ions are taken up and released. They comprise:

a housing sealed in a fluid-tight fashion and consisting of a positively-poled metallic housing half and a negatively-poled metallic housing half, which halves are separated from one another by an electrically-insulating seal,
a positive electrode arranged within the housing and in electrical contact with the positively-poled housing half,
a negative electrode arranged within the housing and in electrical contact with the negatively-poled housing half, and
an ion-conductive separator arranged in the housing between the positive electrode and the negative electrode.

The button cells are specifically characterized in that

the positive electrode comprises a metallic current collector,
the metallic current collector is a porous three-dimensional structure,
the pores of the porous structure are filled with an electrochemically-active material of the positive electrode, and
the porous structure is bonded to the positively-poled housing half by welding.

In conventional button cells, it is unusual for separate current collectors to be provided in a button cell housing. In general, the housing halves of a button cell housing are in direct contact with electrochemically-active materials, and themselves serve as current collectors.

By the use of the porous three-dimensional current collector bonded to the positive housing half by welding, a surprisingly clear improvement in the electrical performance of our button cells has been achieved. We believe that this is due to the fact that the electrochemically-active material of the positive electrode present in the pores of the three-dimensional current collector, on average, is arranged with a significantly smaller clearance to the current collector. As a result of the shortened connection, shortened electrical or ionic diffusion paths are achievable, whereby conductivity of the positive electrode is significantly improved.

Moreover, the electrode is also mechanically stabilized by the current collector. This plays a particular role in the use of active materials with a high lithium-absorption capability: each absorption or release of lithium is associated with a change in volume of the active material particles involved. This perpetual mechanical loading results in degenerative phenomena manifested in a decline in cell capacity. This is counteracted by the use of the porous three-dimensional current collector.

A further advantage proceeds from the direct connection of the three-dimensional porous current collector to the housing by welding. By this arrangement, losses associated with poor contact can be excluded.

It is specifically preferred if the three-dimensional structure is formed of an open-pore metal foam, or a metallic nonwoven, or a fabric or felt of metal fibers. Alternatively, the structure can also comprise a mesh or a grid, where applicable in a multi-layer arrangement.

Appropriate open-pore metal foams and nonwoven materials for use as current collectors are known. In this regard, exemplary reference may be made to EP 0 658 949 A1, in which appropriate metal foams and nonwoven materials are described. Metallic grids and meshes are also known as current collectors in the field of batteries. In this regard, exemplary reference may be made to DE 198 57 638 A1. Appropriate meshes or grids are, for example, expanded metals. Expanded metals are thin metal strips or metal foils first provided with a plurality of interrupted incisions and, thereafter, stretched transversely to the longitudinal direction of the incisions, i.e. expanded, in consequence whereof the metal strips previously formed between the incisions are expanded to form a grid structure.

When reference is made to “pores” of the porous structure, this term is also to be understood to include the interspaces between the bars of a grid or a mesh, or the strands of nonwoven material. Correspondingly, the porosity of the structure is simply to be understood as the ratio of the void volume of all the pores and/or interspaces contained in the structure to the total volume of the structure.

It is specifically preferred if the structure has a porosity of 20% to 99%, specifically 80% to 98%. Preferably, the pores and/or interspaces have maximum diameters of 10 μm to 1500 μm, wherein 10 μm to 1000 μm is particularly preferred, and specifically 10 μm to 250 μm.

Both the above-mentioned foams and nonwoven materials, and the grids and metal meshes, are generally available in the form of strip material or sheet material. The structures required for our button cells can be cut out from these materials, for example, by a stamping or cutting process.

It is specifically preferred if a structure thus formed assumes the form of a cylindrical disk, specifically a disk with a diameter of 3 mm to 100 mm, preferably 3 mm to 30 mm. The thickness of the disk is preferably 20 μm to 10 mm, and more preferably 20 μm to 5 mm. Within this range, a thickness is 50 μm to 5 mm, preferably 100 μm to 5 mm, wherein 100 μm to 4 mm is specifically preferred, and more specifically 100 μm to 3 mm. The dimensions of the structure are tailored to the dimensions of the housing of the button cell.

It is specifically preferred if the porous structure is comprised of aluminium or an aluminium alloy.

The housing of the button cell can likewise be comprised of aluminium or an aluminium alloy. However, it can also be comprised of sheet steel or iron, or at least contain a layer of sheet steel or iron. It is specifically preferred if the positively-poled housing half is comprised of aluminium or an aluminium alloy, whereas the negatively-poled housing half is comprised of sheet steel or iron, or at least contains a layer of one of these materials.

It is preferred if the positively- and negatively-poled housing halves are mutually interconnected in a form-fitting arrangement, wherein deformation of the negatively-poled housing half is required to separate the two housing halves from one another.

Specifically preferably, the two housing halves are configured with a cup-shaped design, each having a cup base, a circumferential cup wall, a cup rim with a terminal cut edge, and an opening which is defined by the cup rim.

It is preferred if the porous structure is positioned flatly and directly on the cup base of the positively-poled housing half, and is directly welded to the cup base of the positively-poled housing half.

In a preferred form (Example A) the dimensions of the two housing halves are mutually tailored such that one of the housing halves (the plug-in part) with the cup rim to the fore can be inserted into the other housing half through the opening defined by the cup rim of the other housing half (the receiving part). For execution of the form-fitting connection, the plug-in part, with the cup rim to the fore, can be inserted into the receiving part wherein, preferably prior to insertion, an appropriate seal is applied to the outer side of the cup wall of the plug-in part. Thereafter, the cup rim of the receiving part is radially compressed or displaced inwards, until the required positive fit is achieved. This process is customarily described as flanging.

In a further preferred form (Example B), a form-fitting connection is completed as follows: a housing half configured with a cup-shaped design is employed, having a cup base, a circumferential cup wall, a cup rim with a terminal cut edge, and an opening which is defined by the cup rim. In a first step, the cup rim of the housing half is radially bent over outwards, specifically such that the bent-over rim assumes an angle of 90° to the circumferential cup wall. As a result, the housing half thus shaped shows a hat-like cross section, wherein the bent-over rim forms the hat brim. With the brim to the fore, the housing half is then positioned centrally on a disk, for example, of sheet steel or iron and which, by reforming, is processed to form a bowl-shaped housing half. To this end, the rim of the disk is turned down radially inwards—over the bent-over cup rim of the cup-shaped housing half such that a circumferential flange is formed. Accordingly, the bent-over cup rim of the cup-shaped housing half engages with the bent-over rim of the bowl-shaped housing half in a U-shaped arrangement. An appropriate seal is preferably applied to the bent-over cup rim of the cup-shaped housing half, prior to the fitting thereof to the disk.

The housing of our button cell preferably comprises two circular or oval plane-parallel housing bases, arranged with a mutual clearance, and an annular housing shell connecting the housing bases. Each of the housing bases has an inner side oriented towards the interior space of the housing, and an outer side oriented in the opposing direction. In Example A, the housing bases are constituted of the cup bases of the two cup-shaped housing halves. In Example B, the housing bases are constituted of the cup base of the cup-shaped housing half and the disk.

The button cell preferably has a height of ≤5 mm, more specifically ≤4 mm. A height of 2 mm to 5 mm is specifically preferred, wherein 2 mm to 4 mm is even more preferred. The height preferably corresponds to the shortest distance between the outer sides of the mutually plane-parallel housing bases of the button cell.

Preferably, the negative electrode of the button cell comprises a metallic current collector, specifically a current collector of copper or copper alloy construction electrically connected to the negatively-poled housing half. The current collector is preferably a three-dimensional structure of an open-pore metal foam or a nonwoven metal material, or a fabric or felt of metal strands, or a mesh or grid, where applicable in a multi-layer arrangement.

Preferably, the metallic current collector for the negative electrode is likewise bonded by welding to the housing, more specifically to the negatively-poled housing half. Preferably, the structural composition thereof is otherwise equivalent to that of the current collector for the positive electrode.

The button cell preferably comprises a housing sealed in a fluid-tight fashion. This means that, in normal operation, fluids can neither be released from the housing, nor penetrate the housing.

The manufacture of the button cell can employ the method described below. In all cases, the method comprises the following steps:

provision of a positive electrode in a positively-poled housing half,
provision of a negative electrode in a negatively-poled housing half,
provision of an electrically-insulating seal,
provision of an ion-conductive separator, and
combination of these components in the button cell to be manufactured.

The method is characterized in that the positive electrode, by a metallic current collector in the form of a porous, three-dimensional structure, is bonded to the positively-poled housing half, and in that the current collector is bonded to the positively-poled housing half by welding.

Welding by resistance welding or a laser is specifically preferred. The use of a laser for the welding of a button cell housing to a metallic current collector is known, for example, in DE 10 2009 060 800 A1. The procedure described therein can also, in principle, be employed in this application. In resistance welding, two metallic substrates are brought into mutual contact. Two electrodes are then applied to the contact region, between which a current flows which causes the substrates to melt in the contact region. A corresponding spot weld or weld seam is formed as a result.

In the button cell to be manufactured, the porous three-dimensional structure is part of the positive electrode. Thus, it is preferably covered by active material of the positive electrode. Specifically, its pores are entirely, or at least partially filled with the active material.

To provide the positive electrode in the positively-poled housing half, an appropriate electrochemically-active material is incorporated in the structure. This preferably occurs after the porous structure has already been welded to the positively-poled housing half. The electrochemically-active material can be incorporated in the porous structure in dry form. Alternatively, however, it is also possible for the electrochemically-active material to be incorporated in the porous structure in the form of a suspension. In the latter case, after incorporation, the suspension medium must generally be removed. To this end, the porous structure can be warmed, where applicable.

To provide the negative electrode, in the simplest case, metallic lithium can be compressed into an appropriate housing half. However, it is also possible to proceed analogously to the provision of the positive electrode, i.e. to provide a housing half with a porous metallic structure welded therein as a current collector and incorporate electrochemically-active material, in dry form or in the form of a suspension, into the porous structure.

In principle, as electrochemically-active materials for the manufacture of the button cell, all materials can be employed that can capture and subsequently release lithium ions. According to the prior art, materials of this type for the positive electrode are specifically lithium metal oxides such as lithium cobalt oxide (LiCoO₂), lithium iron phosphate (LiFePO₄), lithium manganese oxide (LiMn₂O₄) or, for example, LiNi_{1/3}Mn_{1/3}Co_{1/3}O₂ or LiMnPO₄. For the negative electrode, active materials employed in industrial applications at present, in addition to the above-mentioned metallic lithium, also specifically include carbon-based particles such as graphitic carbon, or non-graphitic carbon materials capable of the intercalation of lithium. Moreover, metallic or semi-metallic materials can also be employed, which can be alloyed with lithium or constitute inter-metallic phases. Appropriate metals include, for example, the elements tin, antimony and silicon. All electrochemically-active materials are generally employed in particle form, and are also contained in this form in the electrodes.

Both the positive and the negative electrode, in addition to the above-mentioned active materials, can also contain electrochemically inactive components. These specifically include electrode binders and conductivity-enhancing additives. Electrode binders are generally responsible for the mechanical stability of electrodes. As this function, at least on the side of the positive electrode, is assumed by the porous structure, an electrode binder can be omitted from some forms. Likewise, in some forms, the above-mentioned conductivity-enhancing additives are not absolutely essential, as the structure forms a conductive matrix which, at least in certain parts, also assumes the functions of a conventional conductive agent. Insofar as the electrodes in the button cell incorporate a conductive agent, soot or graphite, for example, may be considered for this purpose. Potential electrode binders include, for example, carboxymethyl cellulose and fluorinated polymers such as polyvinylidene fluoride.

As electrically-insulating seals for our button cell, conventional injection-molded seals are specifically appropriate, together with known film seals from DE 196 47 593 A1.

Potential ion-conductive separators for the button cell include, for example, electrolyte-impregnated plastic films, for example, porous films of polyolefin or polyether ketone construction. Nonwoven materials of polyolefin strands can also be employed.

Before the housing of a button cell is closed, the electrodes are customarily filled with an electrolyte. Commonly-employed electrolyte solutions include, for example, solutions of lithium salts such as lithium hexafluorophosphate, in organic solvents such as ether or carbonic acid esters.

The aforementioned and further advantages specifically proceed from the following description of the drawings, in association with examples described. The preferred forms described hereinafter are intended solely for the clarification and improved understanding and are not, under any circumstances, to be understood by way of limitation.

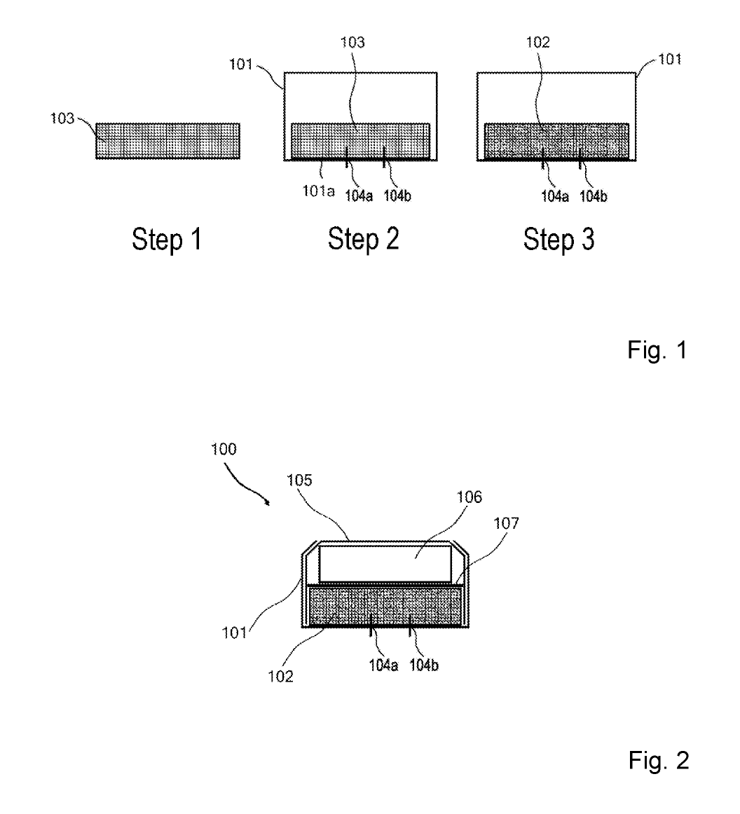

As shown in step 1 of FIG. 1, a disk 103 of an aluminium foam is provided. To this end, the disk 103 is stamped out of a corresponding strip material. In step 2, the disk 103 is pressed into the cup-shaped housing half 101 which consists of aluminium such that it lies flush to the base 101a of the housing half 101. On the outer side of the base 101a, electrodes are then applied at two points 104a and 104b, to which an electrical voltage is applied. As a result of the electrical voltage, in the contact region, the aluminium foam is bonded by melting to the inner side of the base 101a. In step 3, a suspension of N-methylpyrrolidone (NMP) or N-ethylpyrrolidone (NEP) and a lithium metal oxide contained therein (the active electrode material) is introduced into the pores of the aluminium foam. The organic solvent is then removed. By a stamp (not represented), the composite metal foam and active electrode material can then be calendered.

In a subsequent step, the positively-poled housing half 101 provided in step 3, with the electrode 102 contained therein, is combined with a cup-shaped negatively-poled housing half 105, in which a negative electrode 106 is arranged. The resulting form of a button cell 100 is represented in FIG. 2 (again, in a schematic cross-sectional representation).

As the negative electrode 106, metallic lithium can be compressed into the housing half 105. However, an alternative variant is represented in FIG. 2. The electrode 105 represented is essentially comprised of a material which is suitable for the intercalation of lithium such as graphitic carbon. The separator 107 of polyolefin construction is arranged between the electrodes 102 and 105. This, in common with the positive electrode 102 and the negative electrode 106, is impregnated with an electrolyte solution.

The negatively-poled housing half 105 is inserted into the positively-poled housing half 101. The housing is closed by flanging.

1.-13. (Cancelled)

14. A lithium-ion button cell comprising:
a housing sealed in a fluid-tight fashion, comprising a positively-poled metallic housing half and a negatively-poled metallic housing half, which halves are separated from one another by an electrically-insulating seal,
a positive electrode arranged within the housing and in electrical contact with the positively-poled housing half,
a negative electrode arranged within the housing and in electrical contact with the negatively-poled housing half, and
an ion-conductive separator arranged in the housing between the positive electrode and the negative electrode,
wherein
the positive electrode comprises a metallic current collector,
the metallic current collector is a porous three-dimensional structure,
pores of the porous structure are filled with an electrochemically-active material of the positive electrode, and
the porous structure is bonded to the positively-poled housing half by welding.

15. The button cell as claimed in claim 14, wherein the structure is formed of an open-pore foam, a nonwoven material, a grid or a mesh.

16. The button cell as claimed in claim 14, wherein the structure has a porosity of 20% to 99%.

17. The button cell as claimed in claim 14, wherein the porous structure is a cylindrical disk having a diameter of 3 mm to 100 mm and a thickness of 20 μm to 10 mm.

18. The button cell as claimed in claim 14, wherein the porous structure and/or the positively-poled housing half is comprised of aluminium or an aluminium alloy, or of sheet steel or iron and/or the negatively-poled housing half is comprised of sheet steel or iron, or at least incorporates one layer of sheet steel or iron.

19. The button cell as claimed in claim 14, wherein the positively- and negatively-poled housing halves are mutually interconnected in a form-fitting arrangement, and deformation of the negatively-poled housing half is required to separate the two housing halves from one another.

20. The button cell as claimed in claim 14, wherein the negative electrode comprises a metallic current collector of copper or copper alloy construction.

21. The button cell as claimed in claim 20, wherein the metallic current collector for the negative electrode is bonded to the negatively-poled housing half by welding and/or has the same structural properties as the current collector for the positive electrode.

22. A method of manufacturing the button cell as claimed in claim 14, comprising:
providing a positive electrode in a positively-poled housing half,
providing a negative electrode in a negatively-poled housing half,
providing an electrically-insulating seal,
providing an ion-conductive separator, and
combining the electrodes, seal and separator in the button cell to be manufactured, wherein the positive electrode, by a metallic current collector in the form of a porous, three-dimensional structure, is bonded to the positively-poled housing half, and the current collector is bonded to the positively-poled housing half by welding.

23. The method as claimed in claim 22, wherein welding is executed by resistance welding or a laser.

24. The method as claimed in claim 22, wherein, to execute welding, the porous structure is brought into mechanical contact with the housing half, and welding is executed by application of a voltage to the housing half in the contact region.

25. The method as claimed in claim 22, wherein the positive electrode is manufactured by incorporating an appropriate electrochemically-active material into the porous structure after the porous structure has been welded to the positive housing half.

26. The method as claimed in claim 25, wherein the electrochemically-active material is incorporated in the porous structure in dry form or the electrochemically-active material is incorporated in the porous structure in the form of a suspension.

27. The method as claimed in claim 23, wherein, to execute welding, the porous structure is brought into mechanical contact with the housing half, and welding is executed by application of a voltage to the housing half in the contact region.

28. The method as claimed in claim 23, wherein the positive electrode is manufactured by incorporating an appropriate electrochemically-active material into the porous structure after the porous structure has been welded to the positive housing half.

29. The method as claimed in claim 24, wherein the positive electrode is manufactured by incorporating an appropriate electrochemically-active material into the porous structure after the porous structure has been welded to the positive housing half.

30. The button cell as claimed in claim 15, wherein the structure has a porosity of 20% to 99%.

31. The button cell as claimed in claim 15, wherein the porous structure is a cylindrical disk having a diameter of 3 mm to 100 mm and a thickness of 20 μm to 10 mm.

32. The button cell as claimed in claim 16, wherein the porous structure is a cylindrical disk having a diameter of 3 mm to 100 mm and a thickness of 20 μm to 10 mm.
